(19) United States
(12) Patent Application Publication
(10) Pub. No.: US 2019/0036362 A1
(43) Pub. Date: Jan. 31, 2019

(54) EXTERNAL POWER SOURCE DEVICE AND METHOD OF USE

(71) Applicant: Atticus Daravong, Bedford, TX (US)

(72) Inventor: Atticus Daravong, Bedford, TX (US)

(21) Appl. No.: 16/047,767

(22) Filed: Jul. 27, 2018

Related U.S. Application Data
(60) Provisional application No. 62/537,652, filed on Jul. 27, 2017.

(51) Int. Cl. H02J 7/00; H02J 7/02; H04B 1/3883; H04M 1/02

(52) U.S. Cl. CPC H02J 7/0042; H02J 7/0047; H04M 1/0274; H04B 1/3883; H02J 7/025

(57) ABSTRACT

An external power source device for providing power to a mobile electronic device, the external power source device includes a body with a sides; an attachment device positioned on a back side of the body to secure the body to a hard surface of the mobile electronic device; a charging cable having a first end and a second end, the charging cable having a plug secured to the first end; the second end secures to the body; the charging cable provides power to the electronic device through the plug; and the external power source attaches in a low profile means to the hard surface of the mobile electronic device.

### BACKGROUND

### 1. Field of the Invention

The present invention relates generally to charging systems, and more specifically, to an external power source device for conveniently providing power for charging an electronic device.

### 2. Description of Related Art

Charging systems are well known in the art and are effective means to charge electronic devices. For example, FIG. 1 depicts a conventional charging system 101 having a charger 103 plugged into an outlet 105 and a cable 107 connected to a phone 109. During use, the charger 103 provides power to charge the internal battery of phone 109.

One of the problems commonly associated with system 101 is inconvenience. For example, during traveling or many other activities, it is inconvenient for a user to leave their phone near an outlet.

Accordingly, although great strides have been made in the area of charging systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a common charging system;

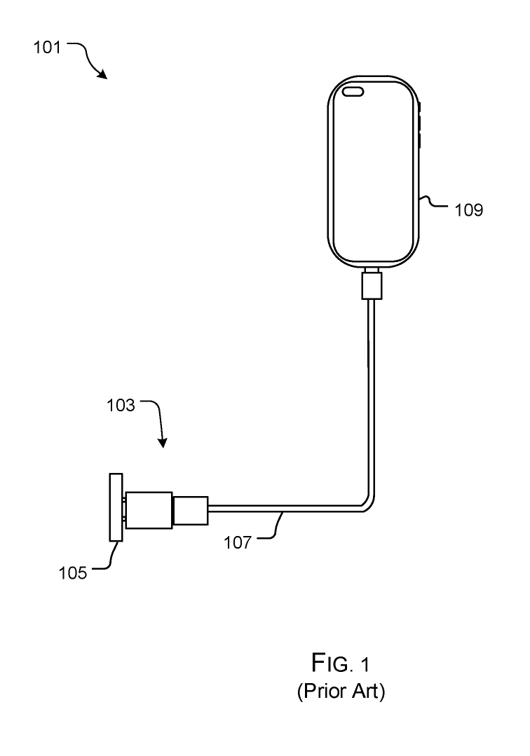

FIGS. 2A and 2B are back views a system with an external power source device in accordance with a preferred embodiment of the present application;

FIG. 3 is a side view of the external power source of FIGS. 2A and 2B;

FIG. 4 is a flowchart of the method of FIGS. 2A and 2B; and

FIGS. 5A and 5B are side views of an alternative embodiment of an external power source in accordance with the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional charging systems. Specifically, the present invention provides a means to charge an electronic device without being near an outlet. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

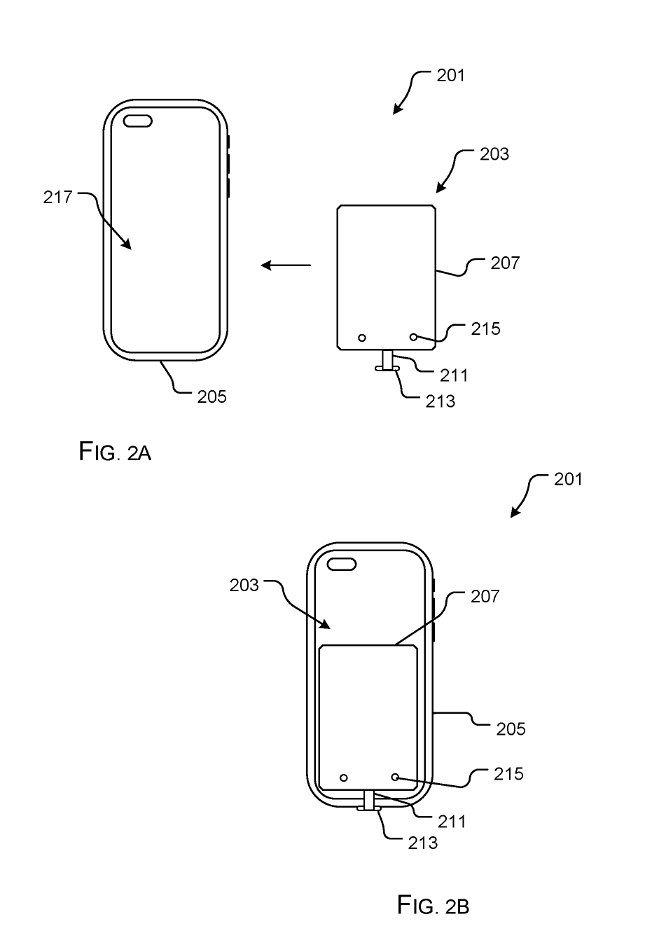

Referring now to the drawings wherein like reference characters identify corresponding or similar elements throughout the several views, FIGS. 2A and 2B depict back views of a charging system 201 with an external power source device 203 in accordance with a preferred embodiment of the present application. It will be appreciated that device 203 overcomes one or more of the above-listed problems commonly associated with conventional charging systems.

In the contemplated embodiment, system 201 includes a mobile electronic device 205 such as a phone, tablet, or computer. In the preferred embodiment, device 203 is specifically adapted for use with a phone, however other embodiments could be sized appropriately to be used with other electronics.

Device 203 includes a body 207 having a plurality of sides and a cord 211 configured to extend from a first end to a second end, wherein the first end is connected to body 207 and the second end has a plug 213 configured to plug into a port (not shown) associated with device 205. Cord 211 is short and substantially flat, thereby allowing for device 203 to maintain a low profile appearance when connected to device 205. In the preferred embodiment, device 203 further includes one or more indicators 215 configured to provide the user with an indication of a charge amount associated with device 203. The indicators could be placed in a variety of positions and could be lights.

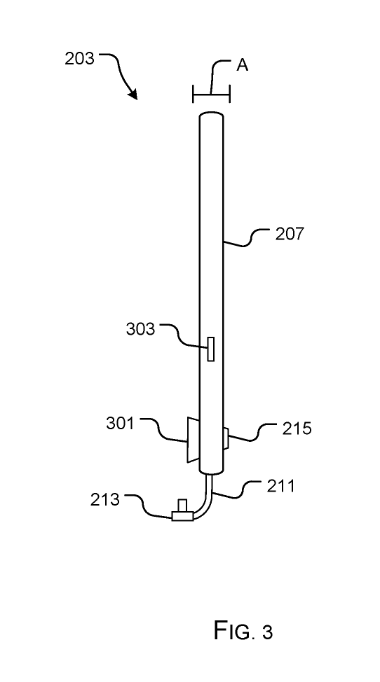

Device 203 houses an internal battery configured to provide charge to device 205 via cord 211. In the preferred embodiment, body 207 is configured to secured to a hard surface 217 via one or more attachment devices (shown in FIG. 3). In one embodiment, an attachment device 301 is an adhesive surface, however other means of attachment could be employed. Contemplated embodiments of suction devices include using nano-suction technology and/or antigravity material, thereby allowing for the attachment device to be cleaned to be reused multiple times after cleaning with tape or a similar tacky material. It should be appreciated and understood that an antigravity adhesive provides a thin layer adhesive surface configured to secure to a hard surface repeatedly without being overly tacky to the touch. In addition, an anti-gravity adhesive can be cleaned via tape, a damp cloth, or a variety of other means to improve the adhesive ability of the surface.

As further shown in FIG. 3, in one embodiment, device 203 has a width (A) at or less than 6 mm, thereby allowing for device 203 to secure to mobile device 201 in a substantially flat, low-profile mechanism. Device 203 can further include a port 303, such as a micro-usb port, configured to provide a means to charge device 203 via an external charging cable. It should be understood that conventional charging cables and/or apparatuses can be used. It should further be appreciated that while charging device 203, the electronic device can be charged simultaneously, wherein charge flows from the charging system, to the external power source, and to the electronic device.

It should be appreciated that one of the unique features believed characteristic of the present application is the configuration of device 203 having an attachment device allowing for the external charging source to be secured repeatedly to a hard surface of an electronic device. The device of the present application provides a means to charge a phone (or other electronic) without the use of the electronic device being interrupted and without the user needing to be near an outlet.

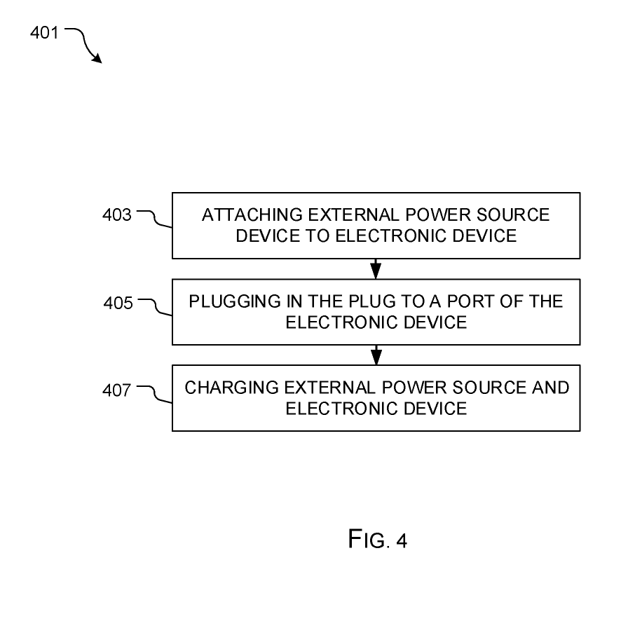

In FIG. 4, a flowchart 401 depicts a method associated with system 201. The external power source device is attached to the electronic device via the attachment means, as shown with box 403. The external power source is plugged into the electronic device to allow the electronic device to charge, as shown with box 405. As necessary, a charging system is plugged into the external power source to charge both the external power source device and the electronic device, as shown with box 407.

It should be appreciated that the materials used to construct device 203 can vary, however fire resistant materials are specifically contemplated to improve the durability of device 203.

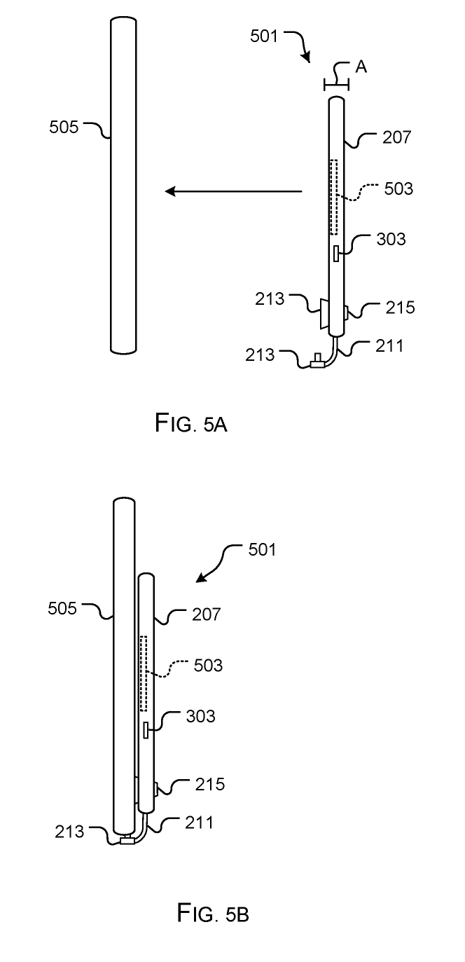

In FIGS. 5A and 5B, side views of an alternative embodiment of a power source 501 is shown, which can include some or all of the features discussed above, but further includes a Qi wireless magnetic power bank 503 configured to provide a means to secure to a phone 505 and provide power thereby.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An external power source device for providing power to a mobile electronic device, the external power source device comprising:
a body with a plurality of sides;
an attachment device positioned on a back side of the body and configured to secure the body to a hard surface of the mobile electronic device;
a charging cable having a first end and a second end, the charging cable having:
a plug secured to the first end;
wherein the second end secures to the body; and
wherein the charging cable provides power to the electronic device through the plug;
wherein the external power source attaches to the hard surface in a low profile position.

2. The external power source device of claim 1, wherein the body has a width at or less than 6 mm.

3. The external power source device of claim 1, wherein the attachment device is a suction cup.

4. The external power source device of claim 1, wherein the attachment device is an anti-gravity adhesive, wherein the anti-gravity adhesive provides an adhesive surface configured to repeatedly secure to the hard surface of the mobile electronic device.gy.

5. The external power source of claim 1, wherein the charging cable is substantially flat.

6. The external power source of claim 1, further comprising:
a power level indicator on the body.

7. The external power source of claim 1, further comprising:
a port positioned into the body and configured to provide a means to charge the external power source.

8. The external power source of claim 7, wherein the port is a micro-usb port.

9. The external power source of claim 1, wherein the body is composed of fire-resistant material.

10. The external power source of claim 1, further comprising:
a QI wireless magnetic power bank.

11. A method of charging a mobile electronic device provided the external power source device of claim 1;
attaching the external power source device to a back surface of the mobile electronic device via the attachment device; and
plugging the plug into a port of the mobile electronic device;
wherein the external power source device provides the mobile electronic device with power.

12. The method of claim 11, further comprising:
plugging a charging system into the external power source via a port in the body; and
charging the external power source and the mobile electronic device.
